(19) United States
(12) Patent Application Publication
(10) Pub. No.: US 2002/0114449 A1
(43) Pub. Date: Aug. 22, 2002

(54) Modular multiplier and an encryption/decryption processor using the modular multiplier

(75) Inventors: Chun-Yang Cheng, Hsinchu (TW); Wei-Chang Tsai, Panchiao (TW)

Correspondence Address: Richard P. Berg, Esq., c/o LADAS & PARRY, Suite 2100, 5670 Wilshire Boulevard, Los Angeles, CA, 90036-5679, US

(73) Assignee: Goldkey Technology Corporation

(21) Appl. No.: 09/916,829

(22) Filed: Jul. 26, 2001

(30) Foreign Application Priority Data
Dec. 21, 2000 (TW) 89127525

(51) Int. Cl. H04L 9/00

(52) U.S. Cl. 380/28

(57) ABSTRACT

A modular multiplier and an encryption/decryption processor using the modular multiplier, which is mainly applied in a chip to have the needs of small size and faster operation. In the modular multiplier, Montgomery algorithm is realized, the operand is divided into the fixed-length data, and the desired result is provided by the iterative calculation. In the algorithm, two recursive structures include the multiplication operation first and the addition operation later. By the multiplexer to data path's choice, the desired result of modular multiplication can be calculated by a single data path at different time points.

### BACKGROUND OF THE INVENTION

1. Field of the Invention

This invention relates to a modular multiplier operation structure, particularly to a modular multiplier realized by the high-radix Montgomery operation algorithm.

2. Description of the Related Art

Due to the requirements of data transfer in networking and digitization, the cryptography for the data security mechanism has spurred efforts to the design. The basic principle of the cryptography is that a plaintext is converted into a ciphertext through a encryption and a encryption key chosen by a user. When a receiver receives the ciphertext, a decryption with respect to the encryption and a respective decryption key of the encryption key can recover the plaintext. Because the data in transfer or storage is in the ciphertext, the data security is achieved since an adversary has no the decryption key to get the transfer data.

The security of a cryptosystems is built on the basis of the potential of extracting the keys. The security of the cryptosystem is indicated by the potential of extracting the keys from the existing data. Current cryptosystem is divided into two types, private key cryptosystem and public key cryptosystem. In private key cryptosystem, encryption and decryption keys are the same, for example, the widely used system is the DES system. The same encryption and decryption keys mean that the keys must be stored in an absolutely secure transmission path to ensure the transfer security. This is the main drawback in private key crytosystem. There is no such a problem in public key cryptosystem. In public key cryptosystem, encryption and decryption keys are different. In a pair of encryption and decryption keys, encryption key is a public key. When the plaintext is encrypted by encryption key into the ciphertext, only the respective decryption key of encryption key can recover it. Also, such a system, e.g. Rivest, Shamir, Adleman (RSA), must offer the guaranty that the respective decryption can not or hardly be extracted without telling it. Accordingly, public key cryptosystem becomes increasingly and leads the world trend in the cryptosystem because besides it has not the key transfer and management problem, the descryption key in public key cryptosystem offers the function of certifying a digital signature.

RSA cryptosystem uses the modular exponentiation operation to generate the encryption/decryption function. The encryption/decryption is expressed as follows:

C=M^{E}(mod N) (1)

M=C^{D}(mod N) (2)

where N=PQ and ED 1 mod(P−1) (Q−1), M is plaintext; C is ciphertext; E is encryption key; and D is decryption key.

N is the product of two prime numbers P and Q. Equation (1) represents the encryption action. The modular multiplication operation (E, N) is used to convert the plaintext M into the ciphertext C. Equation (2) represents the decryption action. The modular multiplication operation (D, N) is used to recover the plaintext M from the ciphertext C. In RSA cryptosystem, the modular exponentiation operation is complex and takes much time in computation. Hence, the modular multiplier is commonly used to realize the modular exponentiation operation, especially to the utilization of Montgomery algorithm. For example, the Montgomery algorithm is used in the basic operation of AB(mod N) as the following algorithm 1:

<Algorithm 1>

R₀=0;

For i=0 to n−1 do

qᵢ=Rᵢ+aᵢB (mod 2) (3)

Rᵢ₊₁=(Rᵢ+aᵢB+qᵢN)/2 (4)

end

where

$$A = {a}_{n - 1} {2}^{n - 1} + {a}_{n - 2} {2}^{n - 2} + … + {a}_{0} ; B = {b}_{n - 1} {2}^{n - 1} + {b}_{n - 2} {2}^{n - 2} + … + {b}_{0} ;$$

and aᵢ, bᵢ, qᵢε {0, 1}.

The foregoing algorithm performs a n-time loop with an n-bit adder and a 1×n multiplier. The performed result for every loop is respectively multiplied by 2⁰, 2¹, 2², . . . , 2ⁿ⁻¹ and then summed total. The final total summed is expressed as follows:

2ⁿRₙ=AB(mod N) (5)

According to equation (5), Rₙ is expressed as follows:

Rₙ=2⁻ⁿAB(mod N) (6)

Therefore, the modular exponentiation operation of equation (1) or (2) is performed by Montgomery algorithm according to the following pre-operation, exponentiation operation, and post-operation:

MGM(M, 2²ⁿ)=2ⁿM(mod N) (7)

MGM(2ⁿM^{a},2ⁿM^{b})=2ⁿM^{a+b}(mod N) (8)

MGM(2ⁿM^{E},1)=M^{E}(mod N) (9)

where MGM(●,●) represents the operand Rₙ executed by Montgomery algorithm, i.e., the result from equation (6) Rₙ=2⁻ⁿAB (mod N).

Because the need of performing n-time loop in algorithm 1 takes time in the computation, the chip area in the high radix(2^{k}) Montgomery algorithm is adopted to efficiently increase the operation speed. The high radix Montgomery algorithm reduces the modular multiplication from one to n/k by dividing the operand A into ┐n/k┌ groups, each group having k bits, when decoding or encoding data, thereby achieving the purpose of increasing the speed. The algorithm is expressed as follows:

<Algorithm 2>

R₀=0;

For i=0 to ┐n/k┌−1 do

qᵢ=(Rᵢ+aᵢB)*N₁(mod 2^{k}) (10)

Rᵢ₊₁=(Rᵢ+aᵢB+qᵢN)/2^{k} (11)

end

where N₁ is satisfied with N*N₁≡−1 (mod 2^{k}), A=a_{┐n/k┌-1} (2^{k})^{┐n/k┌-}

$$A = {{a}_{⌈ n / k ⌉ - 1} ( {2}^{k} )}^{⌈ n / k ⌉ - 1} + {{a}_{⌈ n / k ⌉ - 2} ( {2}^{k} )}^{⌈ n / k ⌉ - 2} + … + {a}_{0} ;$$

and aᵢ, qᵢε{0, 1, 2, . . . 2^{k-1}}, for k >0.

Although the loop in algorithm 2 is reduced, a further reduction for the loop is subjected to algorithm 3, which shifts the operand B by k bits and changes the parameter N into N₂ in order to eliminate the multiplication and addition operations in equation (10). The expression is:

<Algorithm 3>

R₀=0;

For i=0 to ┐n/k┌ do

qᵢ=Rᵢ(mod 2^{k}) (12)

Rᵢ₊₁=(Rᵢ+qᵢ*N₂)/2^{k}+aᵢB (13)

end

where N₂=mN≡−1 (mod 2^{k}).

Likewise, the result for every loop is respectively multiplied by 2⁰, 2¹, 2², . . . , 2ⁿ⁻¹ and then summed total. The final total is expressed as follows:

2^{n+k}R_{┐n/k┌+1}A*2^{k}*B+Q*N₂ (14)

Accordingly, the relationship derived from equation (5) is satisfied as a result of R_{(n/k)+1} and that is:

2ⁿR_{┐n/k┌+1}AB(mod N) (15)

The best advantage in algorithm 3 is the same operation structure as mentioned above, i.e., only a multiplication and addition is executed for the operand Rᵢ₊₁ in equation (13).

Assume that X=Rᵢ+qᵢ*N₂ (16)

Then equation (13) is modified as the following equation:

Rᵢ₊₁=X/2^{k}+aᵢ*B (17)

If Y=X/2^{k}, equation (17) is changed as the following equation:

Rᵢ₊₁=Y+aᵢ*B (18)

Equations (17) and (18) are respectively executed a multiplication and addition operations and the corresponding operands have the same bit number. Therefore, a same data path is used in the computation operation at different time points, thereby saving the area required for a chip.

However, Montgomery algorithm 3 also has the complex computation problem when the required area for the multiplication is broad. In equations (16) and (18), a k×n multiplier is used. If the values n and k are large, for example, k=32 and n=1024, the chip area therefore becomes very broad. For a chip with the strict request of small size, e.g. a Smart Card, this will influence on its operation and application. As to this point, the invention provides a solution by improving the high radix Montgomery algorithm to reduce the chip area and have the high-speed operation.

### SUMMARY OF THE INVENTION

Accordingly, the object of the invention is to provide a modular multiplier and an encryption/decryption processor using the modular multiplier, capable of reducing the chip area and achieving the purpose of high-speed operation.

To realize the above and other objects, the invention provides a modular multiplier, capable of processing a first operand and a second operand in relation to a modulus for performing the modular multiplication operation. The performed operation includes an instruction, which has an internal multiplication and addition operation with inner recursion and an external multiplication and addition operation. The modular multiplier includes a first buffer device for storing the first operand, the first operand is divided into a first plurality of sub-operands with fixed length; a second buffer device for storing the second operand, the second operand is divided into a second plurality of sub-operands with fixed length; a third buffer device for storing the parameter of the modular multiplication operation; a multiplexer device, coupled to the first, the second, and the third buffer devices, for choosing a first multiplication operand and a second multiplication operand from the first sub-operand, the second sub-operand, and the parameter in order according to the required internal and external multiplication/addition operations; a multiplication device, coupled to the multiplexer device, for multiplying the first multiplication operand by the second multiplication operand to obtain a product; and an addition device, coupled to the multiplication device, for outputting an intermediate result according to the product during the internal multiplication and addition operation and outputting the result of the modular multiplication operation according to the product and the intermediate result during the external multiplication and addition operation.

The modular multiplier can be an encryption or decryption processor, for example, RSA cryption processor. The encryption or decryption processor performs the modular exponentiation operation in the encryption/decryption function according to the encryption/decryption key, thereby realizing the modular multiplier. The encryption/decryption processor can be applied to, such as, a Smart Card, especially to a modular multiplier having the needs of requiring a small chip area and higher operating speed.

### BRIEF DESCRIPTION OF THE DRAWINGS

FIG. 1 is a block diagram illustrating a modular multiplier of an embodiment of the invention;

FIG. 2 is a schematic diagram illustrating an adder to be operated in the first sub-loop according to the embodiment of the invention;

FIG. 3 is a schematic diagram illustrating an adder to be operated in the second sub-loop according to the embodiment of the invention;

FIG. 4 is a block diagram illustrating an RSA encryption/decryption processor realized by the modular multiplier of FIG. 1;

FIG. 5 is a schematic diagram illustrating the application of FIG. 4 in a Smart Card according to the embodiment of the invention.

### DETAILED DESCRIPTION OF THE INVENTION

This invention provides a solution for reducing the chip area in the prior art. That is, in the prior art, algorithm 3 needs very broad chip area to implement a k×n multiplier. The following embodiment describes the inventive algorithm first and the modular multiplier structure in relation to the algorithm later.

In order to reduce the required chip area, the n-bit portion (i.e. the operand N₂ in equation (16) and the operand B in equation (18)) in algorithm 3 is grouped to ┐n/k┌ groups, each group having k bits. That is,

<Algorithm 4>

R₀=0;

For i=0 to ┐n/k┌ do

qᵢ=Rᵢ(mod 2^{k}) (19)

For j=0 to ┐n/k┌−1 do

(Rᵢ₊₁)ⱼ=((Rᵢ)ⱼ+qᵢ* (N₂)ⱼ)/2^{k}+aᵢBⱼ (20)

end

end

where qᵢ*(N₂)ⱼ and aᵢBⱼ respectively are the k×k multiplication operation.

In algorithm 4, although the loop j needs extra carry and accumulation operations, the chip area is reduced obviously from k×n to k×k.

The algorithm 4 is further embodied in following algorithm 5:

<Algorithm 5>

R₀=0;

For i=0 to ┐n/k┌ do

qᵢ=Rᵢmod2^{k} (21)

W=qᵢ*(N₂)₀ (22)

C₋₁=(Rᵢ)₀+W[(k−1):0] (23)

V=0 (24)

For j=0 to ┐n/k┌−1 do

Z=W (25)

W=qᵢ*(N₂)ⱼ₊₁ (26)

U=aᵢ*Bⱼ (27)

{Cⱼ,(Rᵢ₊₁)ⱼ}=(Rᵢ)ⱼ₊₁+W[(k−1):0]+Z[(2k −1):k]+U[(k−1):0]+V[(2k−1):k]+Cⱼ₋₁ (28)

V=U (29)

end

end

where W, Z, U, V are temporary buffers, C₋₁, Cⱼ are carry bits, and {Cⱼ, (Rᵢ₊₁)ⱼ} is the total of k-bit addition. More, (Rᵢ)₀+W[(k−1):0] can become zero(i.e. C₋₁=0) if choosing appropriate qᵢ, N₂.

In algorithm 5, two k×k multipliers are used to respectively calculate the operand W in equation (26) and the operand U in equation (27). In fact, algorithm 5 can further uses two sub-loop operations in loop j as following equation 6.

<Algorithm 6>

R₀=0;

For i=0 to ┐n/k┌ do

qᵢ=Rᵢ(mod 2^{k}) (30)

For j=0 to ┐n/k┌−1 do

Yⱼ=((Rᵢ)ⱼ+qᵢ*(N₂)ⱼ)/2^{k} (31)

end

For j=0 to ┐n/k┌−1 do

(Rᵢ₊₁)ⱼ=Yⱼ+aᵢ*Bⱼ (32)

end

end

Likewise, algorithm 6 is further embodied in following algorithm 7:

<Algorithm 7>

R₀=0;

For i=0 to ┐n/k┌ do

qᵢ=Rᵢmod2^{k} (33)

W=qᵢ*(N₂)₀ (34)

C₋₁=(Rᵢ)₀+W[(k−1):0] (35)

For j=0 to ┐n/k┌−1 do

Z=W (36)

W=qᵢ*(N₂)ⱼ₊₁ (37)

{Cⱼ,Yⱼ}=(Rᵢ)ⱼ₊₁+W[(k−1):0]+Z[(2k−1):k]+C ⱼ₋₁ (38)

C₋₁=0 (39)

Z=0 (40)

end

For j=0 to ┐n/k┌−1 do

W=aᵢ*Bⱼ (41)

{Cⱼ,(Rᵢ₊₁)ⱼ}=Yⱼ+W[(k−1):0]+Z[(2k−1):k ]+Cⱼ₋₁ (42)

Z=W (43)

end

end

In algorithm 6 and 7, the loop j in algorithm 5 is divided into two sub-loops. This manner can reduce the requirement of two k×k multipliers to only one k×k multiplier, thereby shrinking the required chip area. Besides, the performance is even faster. For example, when n=1024, k=32, and a clock requirement to a 32×32 multiplication is assumed, executing the first sub-loop j in equation (31) needs (1024/32)=32 clocks and the same clocks as performing the second sub-loop j in equation (32). The entire multiplication operation (i.e. loop i) takes (1024/32+1)×(32+32)=2112 clocks. If the H-Algorithm is used in the 1024-bit RSA encode or decode modular exponentiation operation, the entire circuit takes about 2×2112×1024 clocks(about 4M clocks), i.e., 4n²(n+1)/k² in terms of parameters n and k. Thus, the purposes of smaller chip area and faster operation are achieved at the same time.

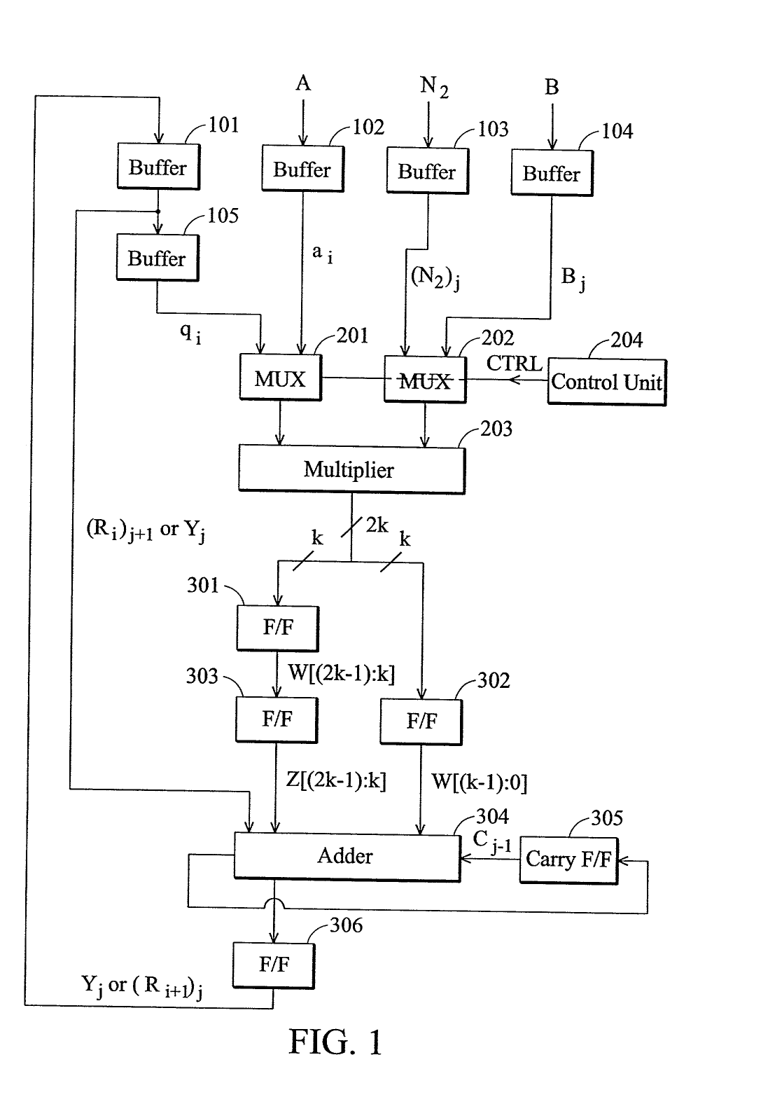

FIG. 1 is a block diagram illustrating a modular multiplier of equation 6 or 7. The modular multiplier structure in FIG. 1 is implemented according to algorithm 7, including buffers 101, 102, 103, 104, 105; multiplexers 201, 202; multiplier 203; control unit 204; flip/flops 301, 302, 303, 305, 306; and adder 304. Each element is described as follows.

Buffer 101 is used to store Montgomery algorithm's result (Rᵢ₊₁)ⱼ or the intermediate operand Yⱼ in the first sub-loop. Buffers 102-105 are used to respectively store the operands A, N₂, B, qᵢ of the two multiplication equations (equations (37) and (41)) in algorithm 7, wherein operands A, N₂, B are a constant, aᵢ is a portion of bits of the operand A in i^{th} loop, (N₂)ⱼ and Bⱼ are a portion of bits of operands N₂ and B in j^{th} loop. According to equation (33), qᵢ stored in buffer 105 is the remainder from Rᵢ/2^{k}, that is, from bit (k−1) to bit 0 in Rᵢ. Hence, the lower k bits of Rᵢ stored in buffer 101 are extracted to have the operand qᵢ in buffer 105.

Multiplexers 201 and 202 are used to switch the required operands in the multiplication operation of different loop. For example, a multiplication operation is required for qᵢ and (N₂)ⱼ in equation (37) of the first sub-loop, while a multiplication operation is required for aᵢ and Bⱼ in equation (41) of the second sub-loop. Multiplexers 201 and 202 are switched by the control signal CTRL of the control unit 204. A multiplication operation is performed by the k×k multiplier 203 with the outputs of 201 and 202 to create the product stored in buffer W with the length 2k.

Flip/flops 301-303 are used to store the result from the multiplier and output the result to the adder 304 to execute the addition operation in equations (38) and (42). Buffer W with the length 2k is divided into two k-length data, wherein the data in low bits W[(k−1):0] is outputted to flip/flop 302, the data in high bits W[(2k−1):k] is outputted to flip/flop 301. Flip/flop 303 stores the high bits Z[(2k−1):k] of the previous multiplication result. Flip/flop 305 stores the carry bit Cⱼ₋₁ of the previous addition result. Adder 304 performs the addition operation in equation (38) of the first sub-loop or in equation (42) of the second sub-loop. The difference between equations (38) and (42) for the addition operation is the operand, using (Rᵢ)ⱼ₊₁ or Yⱼ. When performing the first loop, flip/flop 306 stores the operand Yⱼ while when performing the second loop, flip/flop 306 stores the operand (Rᵢ)ⱼ₊₁, and the two operands Yⱼ and (Rᵢ)ⱼ₊₁ are stored in buffer 101 temporarily.

The operation of the modular multiplier shown in FIG. 1 is described in detail as follows.

According to algorithm 7, the first instruction for every i loop begins with the calculation of the remainder of Rᵢ/2^{k}, that is, taking lower k bits of the operand Rᵢ in buffer 101 into buffer 105.

The operation starts the first sub-loop, which calculates Yⱼ with the parameters qᵢ, (N₂)ⱼ, and (Rᵢ)ⱼ. First, in the 1^{st} sub-loop, the parameter qᵢ in the ith loop is unchanged and comes from buffer 105 for the calculation. Buffer 103 outputs the corresponding (N₂)ⱼ depending on the value j. The higher k bits W[(2k−1):k] and lower k bits W[(k−1):0] of the product for every multiplication operation in the multiplier 203 are inputted to flip/flops 301 and 302, respectively. Inputting the higher k bits to flip/flop 301 is performed by a clock delay. Therefore, the performed result is counted into Yⱼ₊₁ for the addition calculation. The value Yⱼ is calculated by the adder 304 to add together with the lower k bits W[(k−1):0], the higher k bits Z[(2k−1):k] (stored in flip/flop 303) of previous product, (Rᵢ)ⱼ₊₁ (stored in buffer 101), and the overflow bit Cⱼ₋₁ of previous addition operation(stored in flip/flop 305). The calculated result from the adder 304 is stored in buffer 101 at next clock.

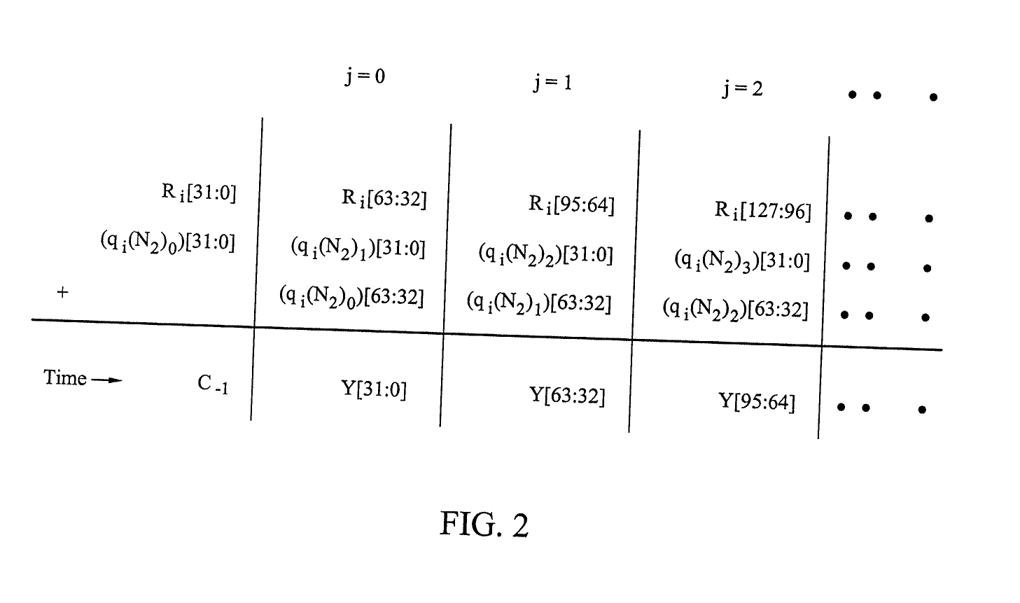

FIG. 2 is a schematic diagram illustrating an adder to be operated in the first sub-loop according to the embodiment of the invention. Assume that k=32 and n=1024, the first column representing the calculation of equation (35). When j=0, the adder 304 adds up Rᵢ[63:32], (qᵢ(N₂)₁) [31:0], (qᵢ(N₂)₀) [63:32], and the carry bit Cⱼ₋₁ and gets Y[31:0]. When j=1, the adder 304 adds up Rᵢ[95:64], (qᵢ(N₂)₂) [31:0], (qᵢ(N₂)₁) [63:32], and the carry bit C₀ and gets Y[63:32]. The remaining operations for j=2 to 31 are all similar. That is, when j=31, Y[1023:992] is found, and Y[1023:0] is completed.

Thus, the second sub-loop sequentially starts at the calculation of (Rᵢ₊₁)ⱼ with the parameters aᵢ, Bⱼ, Yⱼ. Likewise, the parameter aᵢ in the i^{th} loop is unchanged and comes from buffer 102 for the calculation. Buffer 104 outputs the corresponding Bⱼ depending on the value j. The higher k bits W[(2k−1):k] and lower k bits W[(k−1):0] of the product for every multiplication operation in the multiplier 203 are inputted to flip/flops 301 and 302, respectively. Inputting the higher k bits to flip/flop 301 is performed by a clock delay. Therefore, the performed result is counted into (Rᵢ₊₁)ⱼ₊₁ for the addition calculation. The value (Rᵢ₊₁)ⱼ is calculated by the adder 304 to add up the lower k bits W[(k−1):0], the higher k bits Z[(2k−1):k] (stored in flip/flop 303) of previous product, Yⱼ (stored in buffer 101), and the carry bit Cⱼ₋₁ of previous addition operation(stored in flip/flop 305). The calculated result from the adder 304 is stored in buffer 101 at next clock.

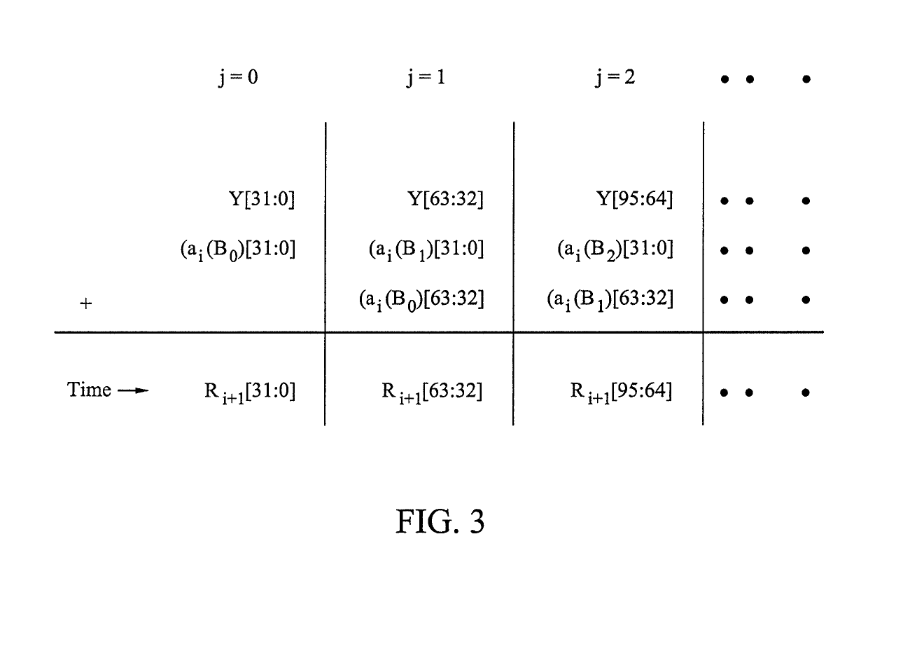

FIG. 3 is a schematic diagram illustrating an adder to be operated in the second sub-loop according to the embodiment of the invention with reference to FIG. 2. When j=0, the adder 304 adds up Y[31:0], (aᵢB₁) [31:0] and (aᵢB₀) [63:32], and gets Rᵢ₊₁ [63:32]. The remaining operations for j=1 to 31 are all similar. That is, when j=31, Rᵢ₊₁ [1023:992] is found, and Rᵢ₊₁ [1023:0] is completed.

Thus, repeated the calculation of Rᵢ for every i and the final result of the Montgomery algorithm is found, which is the modular multiplication of 2⁻ⁿAB (mod N). It is noted that the intermediate content of corresponding flip/flops between the first and second sub-loops is clear in order to use the same data path to calculate different equations. The control unit 204 is used to control the entire operation by a control signal CTRL. The required calculation for the final result of equation 6 or 7 is performed by orderly shifting different multiplication operands into the multiplier.

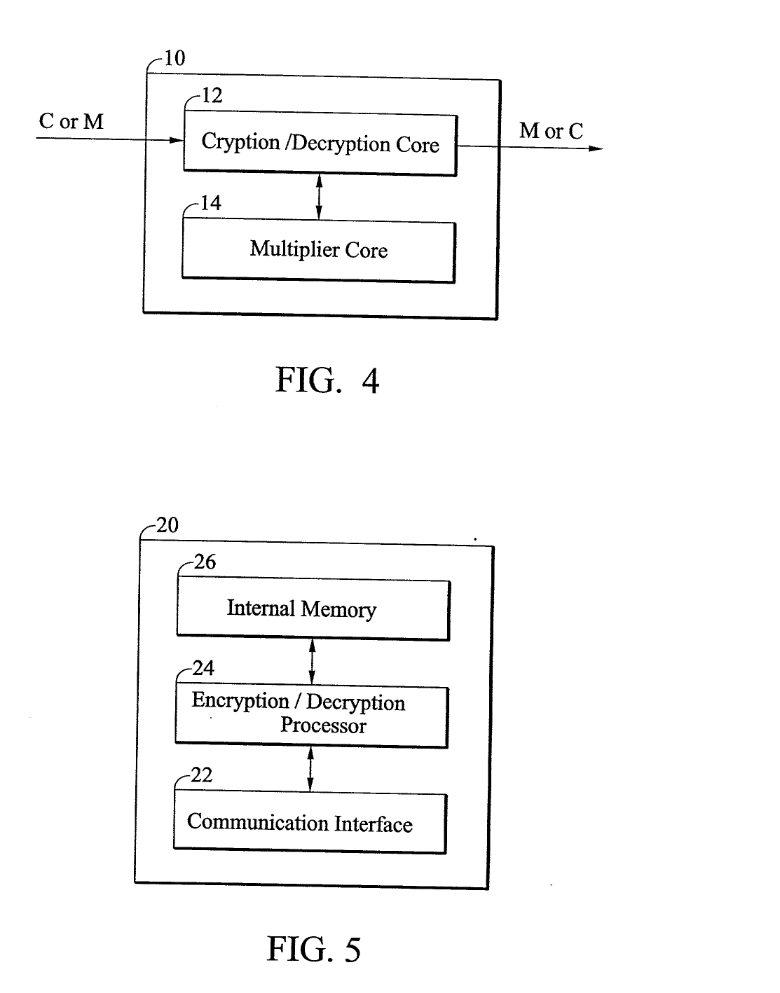

The advantage of the invention is that the inventive modular multiplier can save the chip area and quickly perform the operation concurrently. FIG. 4 is a block diagram illustrating an RSA encryption/decryption processor realized by the modular multiplier of FIG. 1. As shown in FIG. 4, the RSA encryption/decryption processor includes an encryption/decryption core 12 and a modular multiplier core 14. The modular multiplier core 14 can be realized by, for example, the structure of FIG. 1. The modular multiplication result is calculated with the operands A and B. The encryption/decryption core 12 performs the required modular exponentiation operation to encrypt a plaintext to a ciphertext or decrypt the ciphertext to the plaintext using the steps of pre-operation in equation (7), exponentiation operation in equation (8) and post-operation in equation (9).

FIG. 5 is a schematic diagram illustrating the encryption/decryption structure applied to a Smart Card according to the embodiment of the invention. Due to the limits to Smart Card's standard and its facility in carry, the strict chip area is a must. As shown in FIG. 5, the Smart Card 20 exchanges the external data through a communication interface 22. Before the data transfer, the data is encrypted by the encryption/decryption processor 24 through the internal memory 26 of the Smart Card 20 to ensure the data security. Because the need of finishing the required calculation as soon as possible by using the encryption/decryption processor 24 with a smaller area in a chip, the multiplier structure of the invention is the best choice to reach the goal.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A modular multiplier, capable of processing a first operand and a second operand in relation to a modulus for performing a modular multiplication operation, the performed operation including an instruction, which has an internal multiplication and addition operation with inner recursion and an external multiplication and addition operation, the modular multiplier comprising:
a first buffer device for storing the first operand, wherein the first operand is divided into a first plurality of sub-operands with fixed length;
a second buffer device for storing the second operand, wherein the second operand is divided into a second plurality of sub-operands with fixed length;
a third buffer device for storing the parameter of the modular multiplication operation;
a multiplexer device coupled to the first, the second, and the third buffer devices, for choosing a first multiplication operand and a second multiplication operand from the first sub-operand, the second sub-operand, and the parameter according to the required internal and external multiplication/addition operations;
a multiplication device coupled to the multiplexer device, for multiplying the first multiplication operand by the second multiplication operand to obtain a product; and
an addition device coupled to the multiplication device, for outputting an intermediate result according to the product during the internal multiplication and addition operation and outputting the result of the modular multiplication operation according to the product and the intermediate result during the external multiplication and addition operation.

2. The modular multiplier of claim 1, wherein the addition device further comprises:
a first delay component coupled to the multiplication device, for receiving half of the product at the lower-bit portion;
a second delay component coupled to the multiplication device, for receiving half of the product at the higher-bit portion, wherein the second delay component has a multiplication clock more than the first delay component; and
an adder coupled to the first delay component and the second delay component, for receiving intermediate values from the first and second delay components to perform the addition operation.

3. The modular multiplier of claim 1, further comprising an encryption processor for encrypting a plaintext using an encryption key according to a modular exponentiation operation, wherein the modular exponentiation operation is performed by the modular multiplier.

4. The modular multiplier of claim 3, further comprising a decryption processor for decrypting a ciphertext using a decryption key according to the modular exponentiation operation, wherein the modular exponentiation operation is performed by the modular multiplier.

5. The modular multiplier of claim 1-, further comprising a smart card having an encryption/decryption processor for encrypting/decrypting internal data, wherein the encryption/decryption processor performs the encryption/decryption using an encryption/decryption key according to a modular exponentiation operation, and the modular exponentiation operation is performed by the multiplier.

6. A modular multiplier, capable of processing a first operand and a second operand in relation to a modulus for performing a modular multiplication operation, the performed operation including an external loop and an internal loop, the the internal loop having an instruction, which has an internal multiplication and addition operation with inner recursion and an external multiplication and addition operation, the modular multiplier comprising:
a first buffer device for storing the first operand, wherein the first operand is divided into a first plurality of sub-operands with fixed length, each sub-operand respective to the external loop;
a second buffer device for storing the second operand, wherein the second operand is divided into a second plurality of sub-operands with fixed length, each sub-operand respective to the internal loop;
a third buffer device for storing a first and a second parameters of the modular multiplication operation;
a multiplexer device coupled to the first, the second, and the third buffer devices, for choosing a first multiplication operand and a second multiplication operand, which are selected from one of the two groups, the first sub-operand and parameter and the second sub-operand and parameter according to the required internal and external multiplication/addition operations;
a multiplication device coupled to the multiplexer device, for multiplying the first multiplication operand by the second multiplication operand to obtain a product;
an addition device coupled to the multiplication device, for outputting an intermediate result according to the product during the internal multiplication and addition operation and outputting the result of the modular multiplication operation according to the product and the intermediate result during the external multiplication and addition operation; and
a controller for outputting a control signal to control the multiplexer.

7. The modular multiplier of claim 6, wherein the addition device further comprises:
a first delay component coupled to the multiplication device, for receiving half of the product at the lower-bit portion;
a second delay component coupled to the multiplication device, for receiving half of the product at the higher-bit portion, wherein the second delay component has a multiplication clock more than the first delay component; and
an adder coupled to the first delay component and the second delay component, for receiving intermediate values from the first and second delay components to perform the addition operation.

8. The modular multiplier of claim 6, further comprising an encryption processor for encrypting a plaintext using an encryption key according to a modular exponentiation operation, wherein the modular exponentiation operation is performed by the modular multiplier.

9. The modular multiplier of claim 8, further comprising a decryption processor for decrypting a ciphertext using a decryption key according to the modular exponentiation operation, wherein the modular exponentiation operation is performed by the modular multiplier.

10.The modular multiplier of claim 6, further comprising a smart card having an encryption/decryption processor for encrypting/decrypting internal data, wherein the encryption/decryption processor performs the encryption/decryption using an encryption/decryption key according to a modular exponentiation operation, and the modular exponentiation operation is performed by the multiplier.
